(19) United States
(12) Patent Application Publication
(10) Pub. No.: US 2006/0110713 A1
(43) Pub. Date: May 25, 2006

(54) Initial teaching alphabet for teaching phonetics

(76) Inventor: Stephen Guffanti, Vista, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/528,321

(22) PCT Filed: Sep. 15, 2003
(86) PCT No.: PCT/US03/30790

§ 371 Date: Sep. 26, 2005

Related U.S. Application Data
(60) Provisional application No. 60/411,270, filed on Sep. 16, 2002.

(51) Int. Cl. G09B 1/00; G09B 19/00

(52) U.S. Cl. 434/167

(57) ABSTRACT

Systems and methods of teaching phonics represent words using ordinary spelling, and adjacently positioned clarifying symbols that consist primarily or entirely of the letters of a standard alphabet are used to assist in sounding out the words. Single ones of the vowel letters are preferably used to represent corresponding short vowel sounds, and combinations of the vowel letters are preferably used to represent long vowel sounds. The clarifying symbols preferably comprise an Initial Teaching Alphabet having 36 phonograms, which consists of standard letters of the English alphabet plus combinations of those letters. Various prompts are also contemplated, including underlining to highlight a plurality of the letters that form a blended sound, and coloration to show that certain letters are either silent or are sounded according to the adjacent phonetic symbol.

This application claims priority to provisional application 60/411,270, filed on Sep. 16, 2002, the entirety of which is incorporated herein by reference.

### FIELD OF THE INVENTION

The field of the invention is phonics.

### BACKGROUND OF THE INVENTION

English and other modern Western languages are predominantly phonetic languages. Unfortunately, they have been corrupted over time by the importation of foreign spellings and sounds in ways that significantly defeat the originally simple correlation between letters and sounds. Today, for example, of the 26 letters in the normal English alphabet only one (v) has a-unique sound (i.e. a letter that is always pronounced the same). These inconsistencies create learning barriers for children and adults.

Learning to read using phonics is clearly superior to the sight-word reading touted by some during the last few decades. Disputes remain, however, in how to teach phonics effectively. Scholars generally agree on the first step of associating sounds with characters, but then the opinions immediately diverge. One strategy is to teach ordinary Western lettering (A-Z) in combination with a series of rules that specify the circumstances under which the same letters are spoken with different sounds. Such “rules based phonics” can be effective, especially where the rules are incorporated into card and board games. Examples are The Phonics Game™ and Hooked on Phonics™.

Unfortunately, rules based phonics has a large number of rules and an even larger number of exceptions to those rules. To circumvent that problem several scholars have adopted a second strategy that uses an initial teaching alphabet (ITA). An ITA is a substantially pure phonemic alphabet, in which each letter or character always represents the same sound. One of the earliest ITAs was the Pitman™ alphabet shown in FIG. 1. A currently popular ITA is the Deseret™ alphabet shown in FIG. 2. Other ITAs are the Training Wheels™ and Quickscript alphabets shown in FIGS. 3 and 4, respectively. Other examples of ITAs are Akses™, Altscript™, Karmeli™, Mesa™, Moon™, and Unifon™ alphabets.

Numerous advantages have been attributed to the use of initial teaching alphabets. Proponents claim that the use of an ITA makes reading easier and more enjoyable for beginners, and that users rapidly progress to more varied and more difficult text sources. Proponents also claim that ITAs provide increased comprehension, reduced incidence of dyslexia, as well as improved writing and spelling. Still other claimed benefits are ready acceptance and even enthusiasm by teachers.

Detractors argue that the use of an initial teaching alphabet requires users to learn to read twice; once with the ITA and once with a standard alphabet. Certainly there is a dearth of reading materials published in any of the ITAs, so that readers may experience considerable frustration in their inability to read many comics, newspapers and other printed materials. Parents often find it difficult to teach reading to their children using an ITA, and there are, of course, significant problems when a child moves from a school system that uses an ITA to a system that uses a standard alphabet.

These problems are all exacerbated in proportion to the extent of the differences between the ITA being used and a standard alphabet. Thus, someone learning to read using the Deseret or Quickscript alphabets can be expected to have a much more difficult time transitioning to a standard alphabet than would the same person using the Pitman or the Training Wheels alphabets.

There are some ITAs that rely entirely, or almost entirely, on the letters of a standard alphabet. In those cases each of the letters is given a specific, unvarying sound, which distinguishes the ITA from the ordinary alphabet, in which letters have varying sounds in different words. FIG. 5 shows the same text in six different ITAs, using substantially only the 26 characters of the English alphabet.

The problem there, of course, is that the spelling of the words is inconsistent with the ordinary spelling. The closest appears to be RiteSpell, but even there the spelling of almost every word is inconsistent with ordinary spelling. Thus, even the use of ITAs that correspond closely to a standard alphabet requires the user to mentally relearn a great many spellings when moving on to use of the standard alphabet.

Thus, there is still a need to provide systems and methods for teaching reading that utilize an ITA that consists primarily or entirely of the letters of a standard alphabet, while still depicting words with their ordinary spellings.

### SUMMARY OF THE INVENTION

The present invention provides systems and methods in which words are represented using ordinary spelling, and adjacently positioned clarifying symbols that consist primarily or entirely of the letters of a standard alphabet are used to assist in sounding out the words.

In preferred embodiments, single ones of the vowel letters are used to represent corresponding short vowel sounds, and combinations of the vowel letters are used to represent long vowel sounds. Clarifying symbols need not be used for every letter of every word, and indeed in preferred embodiments many words are written without any clarifying symbols at all.

In the most preferred embodiments the clarifying symbols comprise an Initial Teaching Alphabet consisting of the standard 26 letters of the English alphabet (a, b, c, d, e, f, g, h, i, j, k, l, m, n, o, p, q, r, s, t, u, v, w, x, y, z). Contemplated ITA preferably have less than 44 phonograms, more preferably less than 40 phonograms, and still more preferably 36 phonograms. To retain the relatively low number of phonograms, differences in case of the letters are not used to represent differences in sound. Thus, the 26 letters identified above include the corresponding upper case letters.

As used herein adjacent positioning means that the clarifying symbols are at least as close, and preferably closer, to the corresponding letters in the written word than to other letters of the word. This excludes phonetic spelling aids found in dictionaries, in which an entire word is followed by an entire phonetic spelling of the word. In especially preferred embodiments the clarifying symbols are written directly below the corresponding letters of the word.

The teaching of reading using the inventive systems and methods can be advantageously facilitated using various prompts, such as underlining to highlight a plurality of the letters that form a blended sound, and coloration to show that certain letters are either silent or are sounded according to the adjacent phonetic symbol. The prompts are thus distinct from the symbols of the ITA because they merely highlight differences in pronunciation as an aid to reading. They do not control the pronunciation.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a chart of the Pitman alphabet.

FIG. 2 is a chart of the Deseret alphabet FIG. 3 is a chart of the Training Wheels alphabet.

FIG. 4 is a chart of the Quickscript alphabet.

FIG. 5 is a table showing the same text written according to different initial teaching alphabets.

FIG. 6 is a chart showing sounds of a preferred initial teaching alphabet.

FIG. 7 is a chart distinguishing phonograms in the ITA of FIG. 6 that represent short vowel sounds from those that represent long vowel sounds.

FIG. 8 is a chart correlating a reduced set of phonograms with images.

FIG. 9 is a page from a training book, in this case describing a bingo type game.

FIG. 10 is another page from a training book, in this case providing instructions on pronunciation of consonants, and more generally the blending of sounds into words.

FIG. 11 is a plan drawing of a sample peeker window.

FIG. 12 is another page from a sample training book, in this case providing instructions on reading practice, and providing a list of words upon which the child can practice.

FIG. 13 is a sample page from a listing of common words.

FIG. 14 is another page from a training book, in this case providing instruction on leaning to read two-letter blends.

FIG. 15 shows a page used to play bingo using two letter blends.

FIG. 16 is another page from a training book, providing additional instructions on using preferred prompts, including faded out letters.

FIG. 17 is another page from a training book, describing the use of faded out letters to designate which letters are silent versus which letters are pronounced.

FIG. 18 is another page from a training book, focusing on separating and accenting syllables.

FIG. 19 is another page from a training book, providing additional instruction and practice in pronouncing vowels.

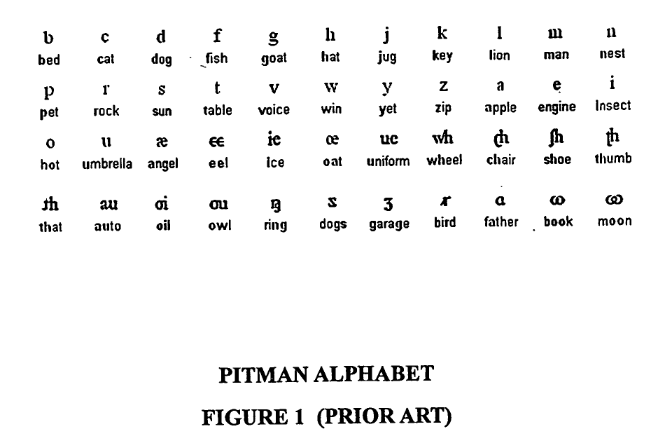

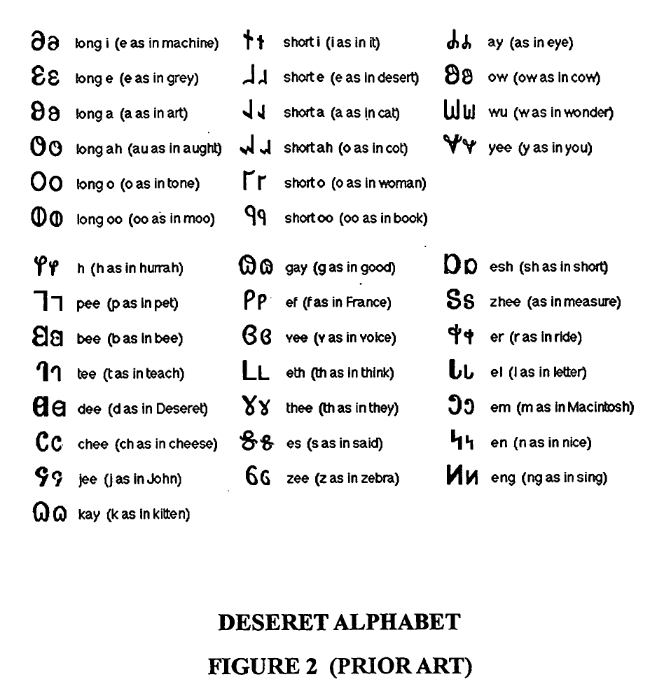

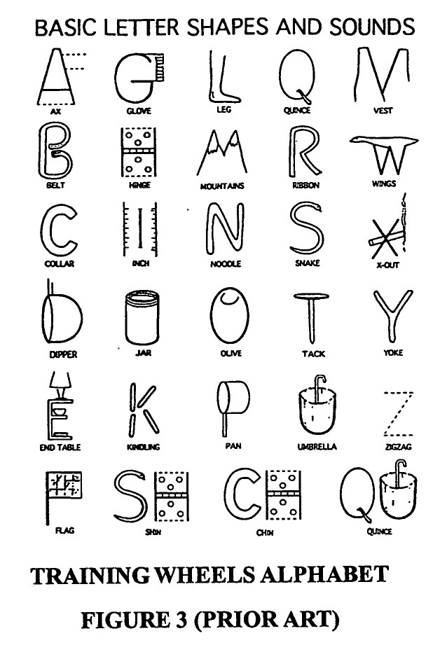

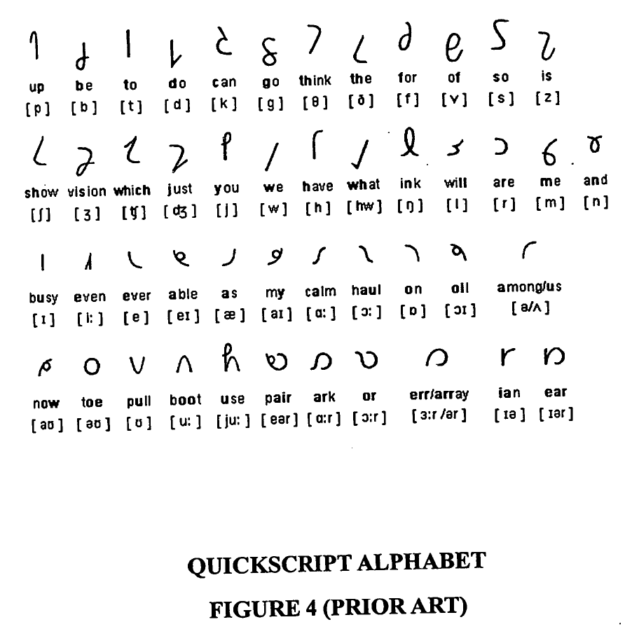

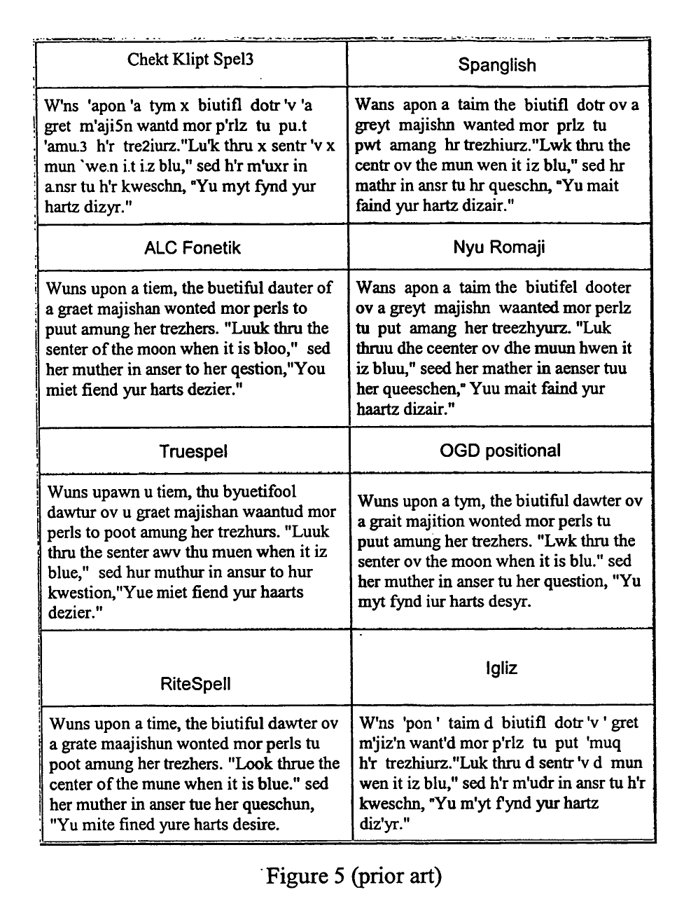

### DETAILED DESCRIPTION

The preferred Initial Teaching Alphabet, along with related materials and methods comprise a system, which for the time being is completed to be marketed under the rubric “Rocket Phonics™”. Other names may be employed over time for the entire system or parts thereof, but for convenience the name Rocket Phonics™ is used herein from time to time as shorthand for the entire system as currently developed.

The goal of Rocket Phonics™ is to create independent readers; readers who can recognize and comprehend in print most of their spoken vocabulary. Since reading is often taught to children and students, the terms “child” and “student” are used herein interchangeably to refer to any person using some or all of the system to learn reading skills. Those terms, however, should be construed herein as euphemisms that includes all persons using the system regardless of age or occupation.

Rocket Phonics™ generally has a three-step approach: (1) teach a preferred initial teaching alphabet (ITA) in which each symbol has a unique sound, (2) teach sound blending, and (3) get the student reading.

Step 1, Teaching a Preferred Initial Teaching Alphabet

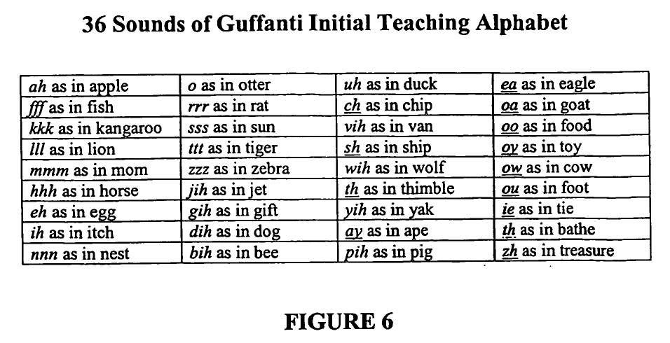

In a first step, Rocket Phonics provides an ITA of 36 symbols. The preferred ITA is designed to retain as much as possible the shape of the word, so the match between shape and sound is retained. For this reason the preferred ITA uses only the 24 letters of the English alphabet and combinations. The 36 sounds of the preferred ITA are depicted in FIG. 6. Note that some of the sounds are depicted by repeated instances of the same letter. Thus, the symbol “mmm” is used to represent the sound of “m” in “mom”. In practice, either the three-letter representation or the single letter representation can be used for the sound. Indeed, the practice materials of the lessons generally depict the sound “m” using the single letter, while the chart on FIG. 6 shows the three letter representation. This inconsistency is maintained because it is a standard convention used to differentiate the sound of a letter over its name.

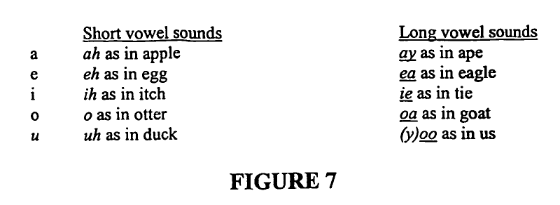

FIG. 7 provides a chart used to conveniently compare the symbols used for the short and long vowel sounds in the ITA of rocket Phonics.

It is important to appreciate that the inventive concepts herein are not limited to one particular ITA. The present invention contemplates ITAs using different letter combinations from those shown in FIG. 6. Thus, an alternative contemplated ITA could use the double letter “ee” to represent the long “e”, as opposed to the combination “ea” to represent that same sound.

It is highly preferred that most of the phonograms are letters in a standard alphabet, such as the 26 letters (a, b, c, d, e, f, g, h, i, j, k, l, m, n, o, p, q, r, s, t, u, v, w, x, y, z) in the English alphabet. To retain the relatively low number of phonograms, differences in case of the letters are not used to represent differences in sound. Thus, the 26 letters identified above include the corresponding upper case letters. It is, however, contemplated that an alternative ITA could use at least some symbols that are not part of the ordinary (i.e. standard) English alphabet. For example, an alternative ITA could use a bar over a single vowel to represent the long sound of the vowel, and the vowel without the bar to represent the short sound of the vowel. Similarly, an alternative ITA could use the capital letter “E” to represent the long vowel sound, and the small letter “e” to represent the short vowel sound.

Where the inventive concepts are applied to languages other than English, it is preferred that the symbols of the corresponding ITAs are also substantially limited to the basic letters of the appropriate alphabets.

Although the most preferred ITA for the present invention uses only 36 symbols (23 of the 26 letters of the English alphabet, plus 13 multi-letter combinations), it is contemplated that alternative ITAs would contain other numbers of symbols. Indeed, many scholars consider there to be 40, 44, or even more than 44 distinct sounds in the English language. Those claims are not disputed herein. Instead, one underlying feature of certain aspects of the inventive subject matter is an appreciation that many of the sounds in the English language are so close to one another as to make it disadvantageous to teach the distinctions among those sounds during the early phases of learning to read. Thus, preferred ITAs consist of less than 44 phonograms, more preferably less than 40 phonograms, and still more preferably 36 phonograms.

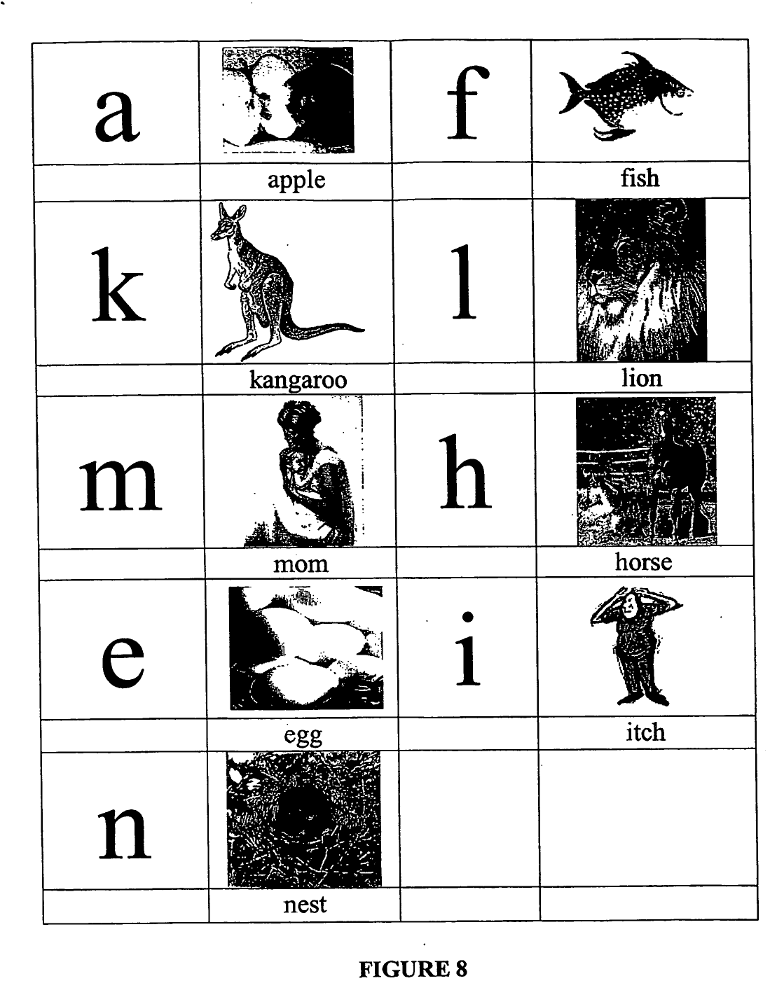

Various picture materials have been found to aid in correlating sounds with the symbols of the ITA. FIG. 8 shows a page from a training book used to teach such sound-symbol correlations. In this instance nine symbols of the ITA (the letters a, f, k, l, m, h, e, i, and n) are shown next to pictures of objects where the sounds of the symbols are included in the names of the objects. Other pages (not shown) are used to correlate other symbols with pictures and sounds as part of the first step of teaching an initial teaching alphabet.

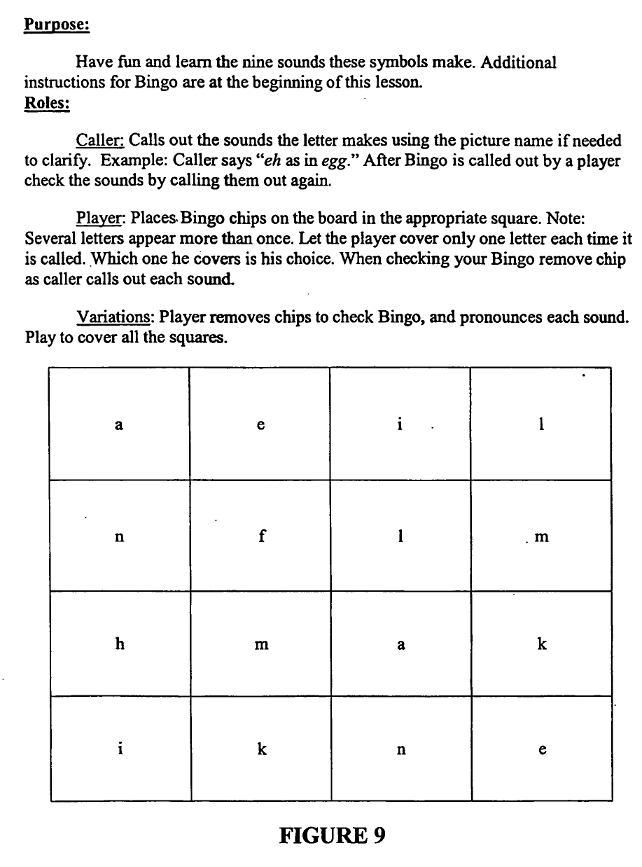

FIG. 9 is another page from a training book, in this case describing a bingo type game that can be used to practice the symbols shown in FIG. 8. Many different games are contemplated, some of which include flash cards with sound-symbols on one side of the card and a picture or diagram on the flip side.

Step 2, Teaching Sound Blending

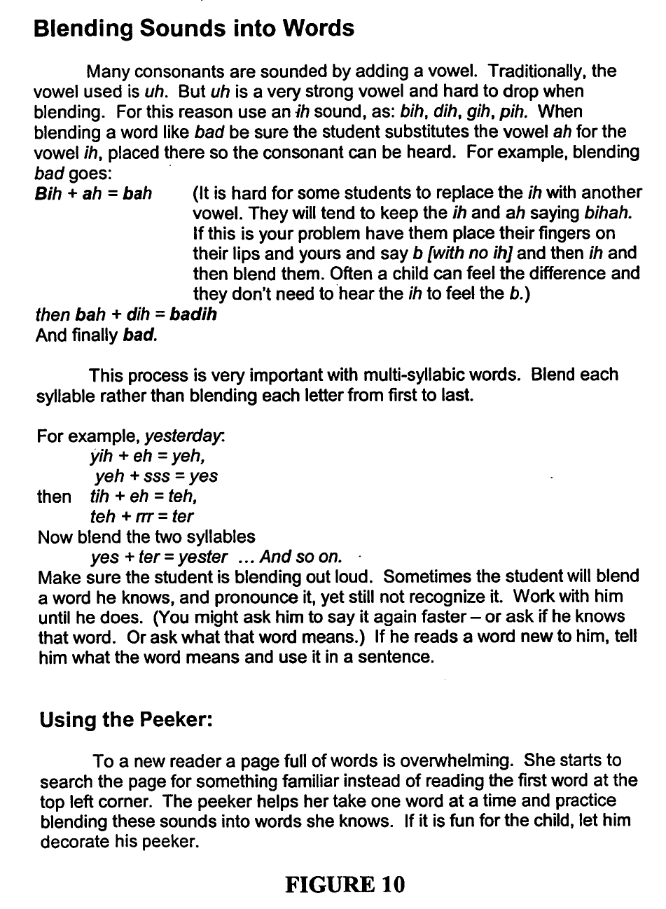

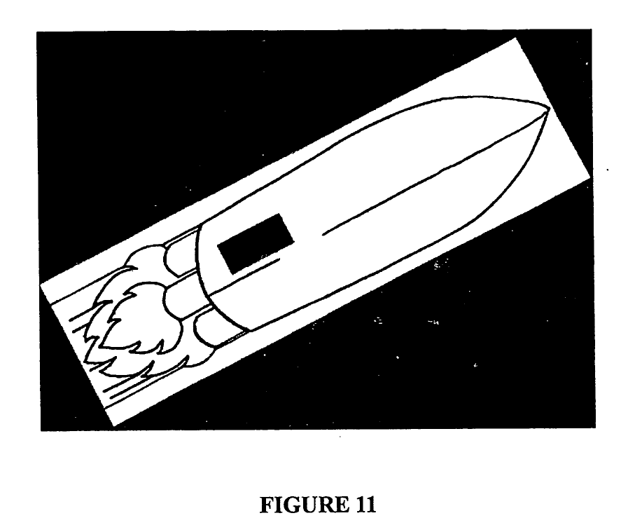

FIG. 10 is another page from a training book, in this case providing instructions on pronunciation of consonants, and more generally the blending of sounds into words. Certainly these and any of the other instructions described herein could be compressed, expanded, re-written or in many other ways revised. Thus, although the instructions here describe pronouncing of consonants using the “ih” sound rather than the traditional “uh” sound, instructions on use of the latter are also contemplated.

The “pecker” referenced at the end of the page of FIG. 10 is a card having a window through which a child views a word and its associated adjacently positions symbols. Selecting an appropriate size for the window relative to the text being read assists in blocking out other words, which in turn assists in focusing the child on the word being read. A sample peeker is shown in FIG. 11. The particular peeker has a line drawing of a rocket, and a window measuring approximately 4 cm by 1.7 cm.

Step 3, Getting the Student Reading.

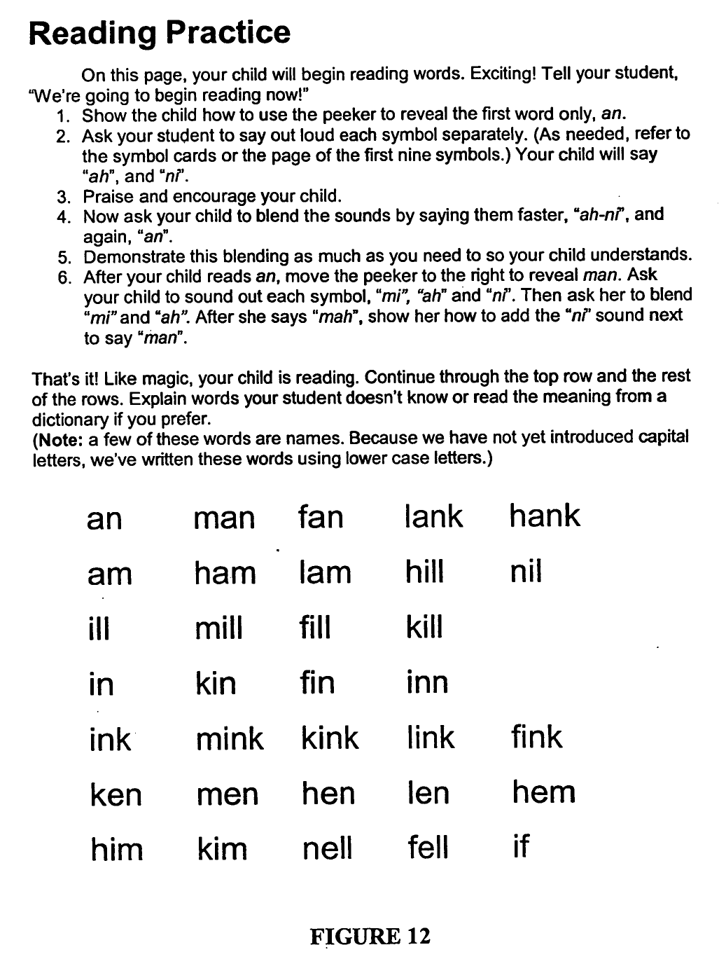

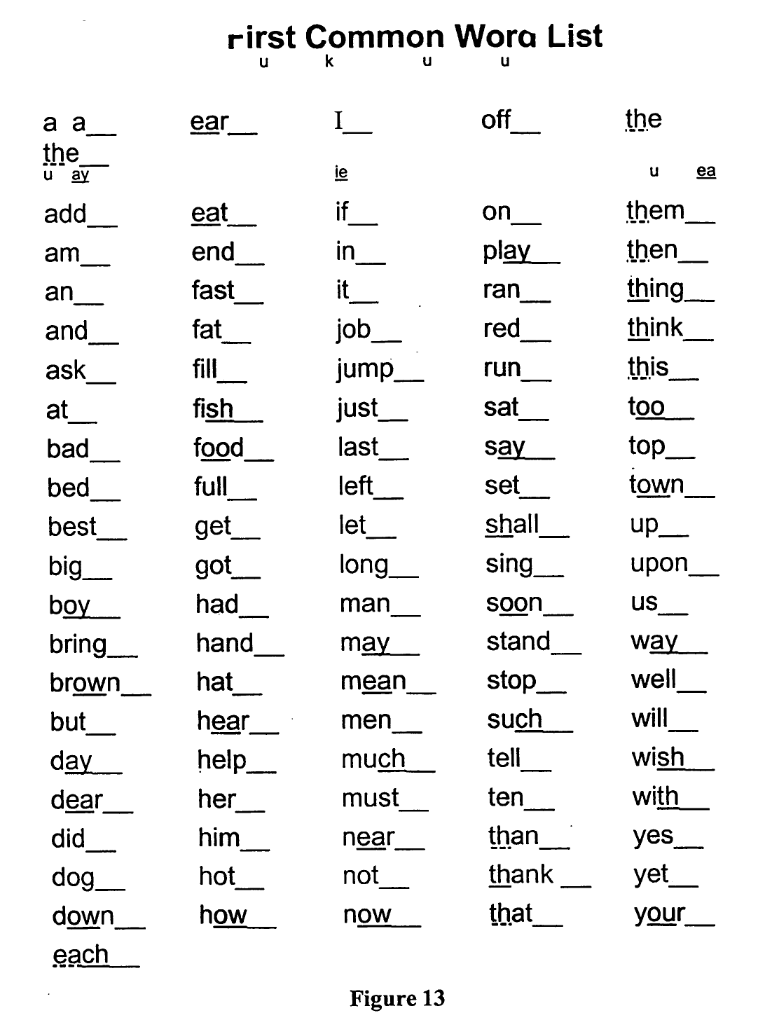

After a child reads a word in the ITA a few times, the child is provided with the normal spelling to see if he can read it. FIG. 12 is yet another page from a sample training book, in this case providing instructions on reading practice, and providing a list of words upon which the child can practice. A longer listing of common words is preferably included in the training materials. FIG. 13 is a sample page of such a listing.

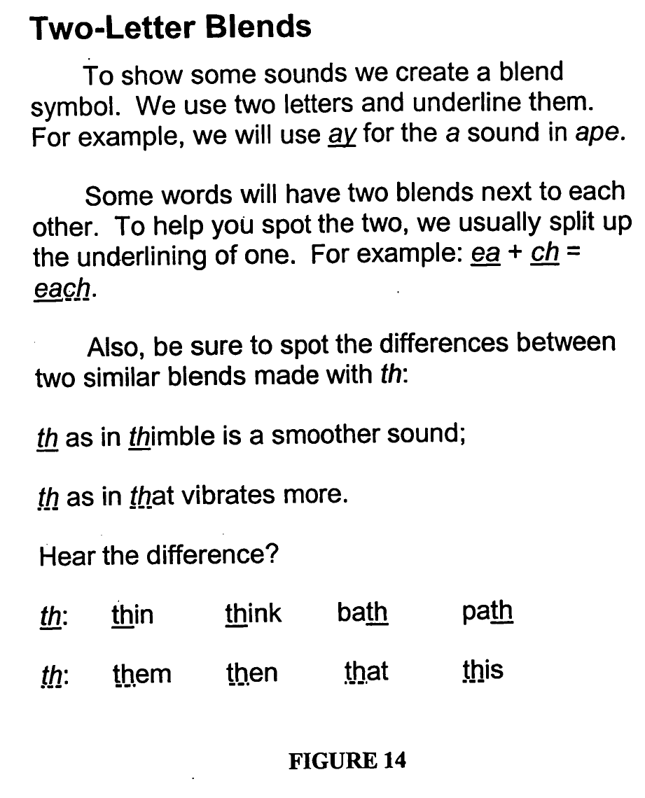

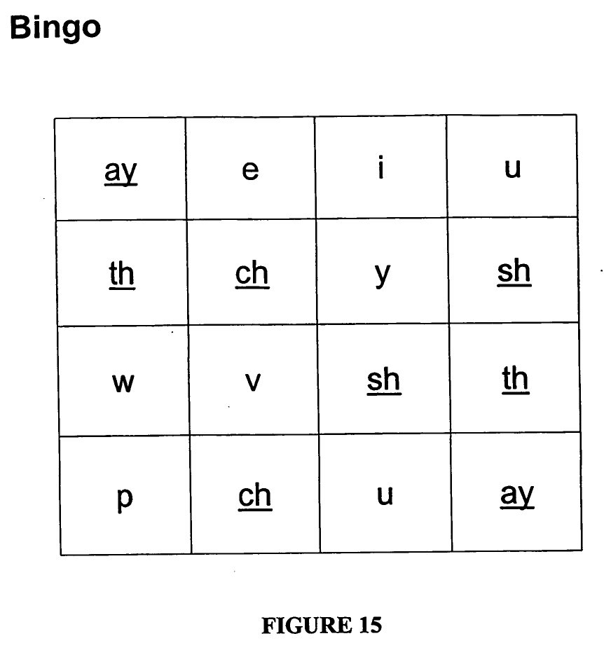

FIG. 14 depicts yet another page from a training book. Here the focus is on learning to read two-letter blends. This page also distinguishes two of the prompts, solid underlining and dotted or dashed underlining. FIG. 15 shows a page used to play bingo using two letter blends.

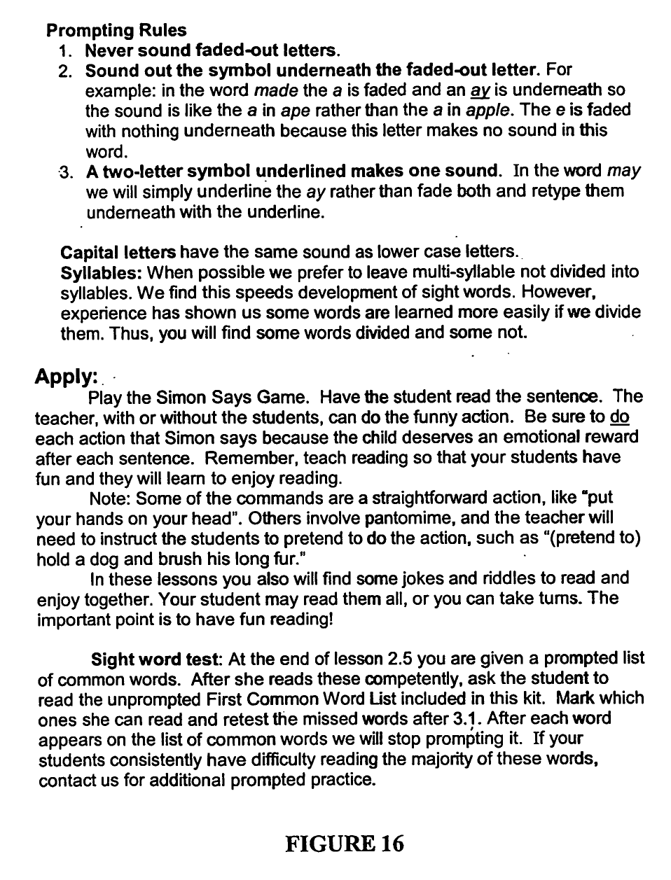

FIG. 16 provides additional instructions on using preferred prompts, including faded out letters. As used herein, the term “prompt” refers to aspects that are not part of the ITA. Prompts do not themselves represent sounds, nor do they alter the way sounds are pronounced. This distinguishes them from, for example, the accent symbols in French. The currently preferred prompts include coloration and faded printing of letters of the word being pronounced, as well as underlining of letters in the words or adjacent ITA symbols.

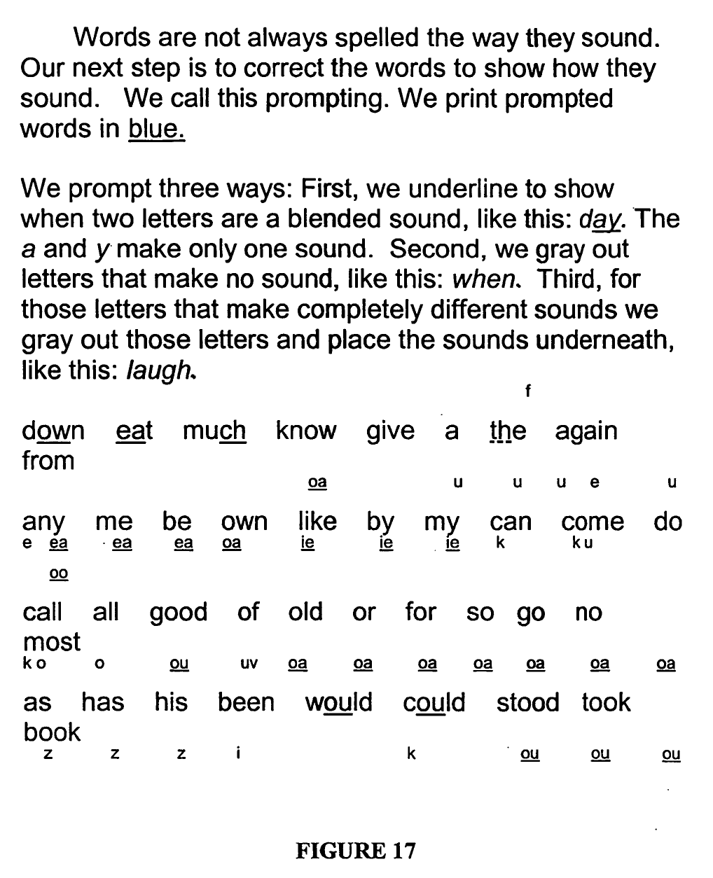

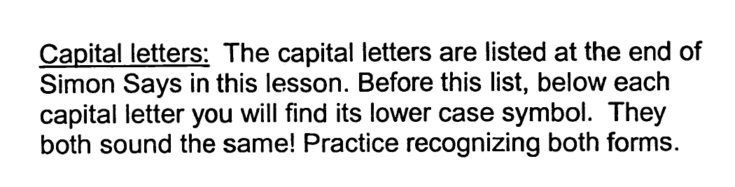

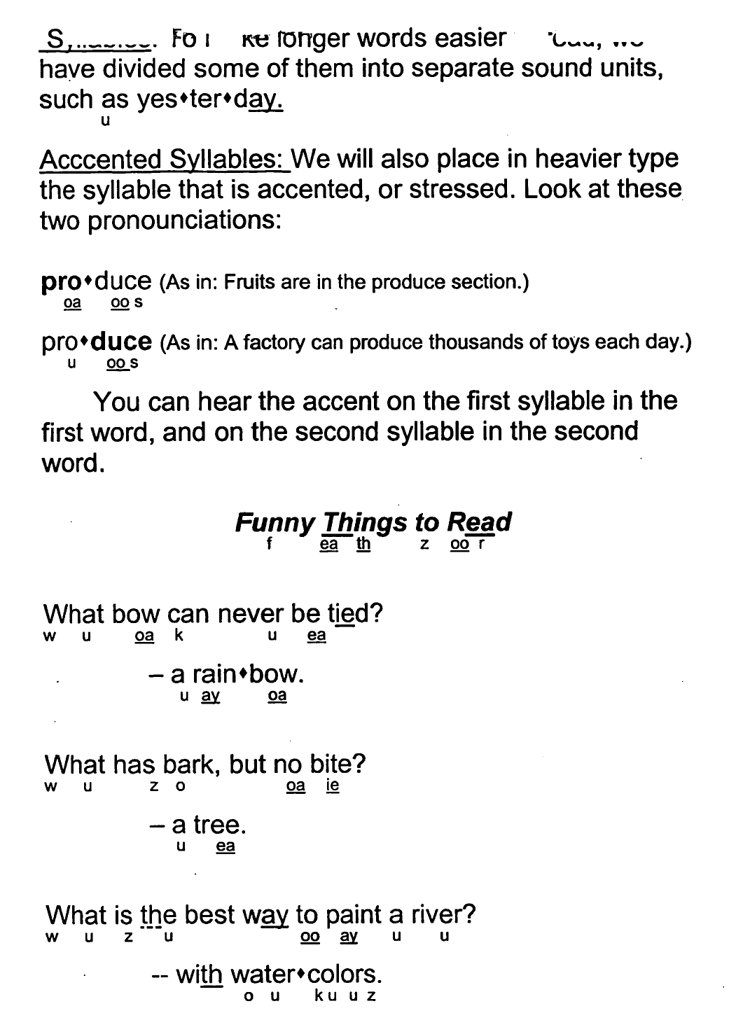

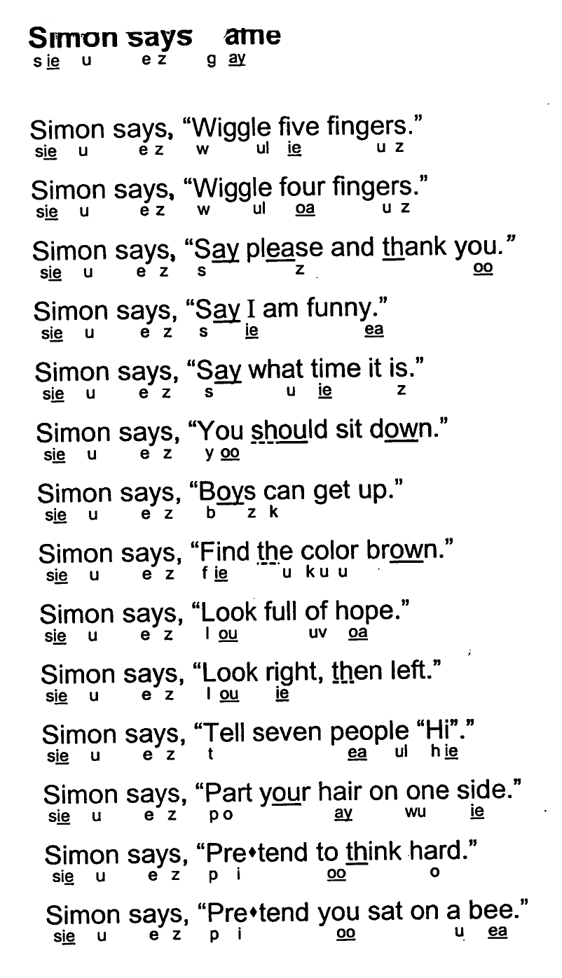

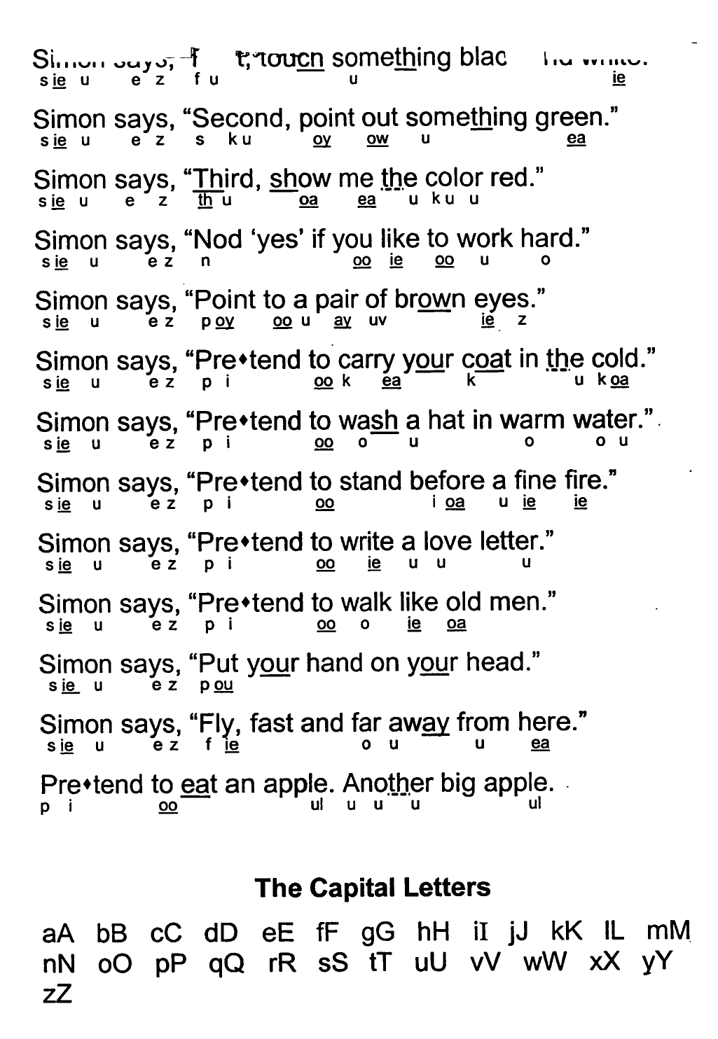

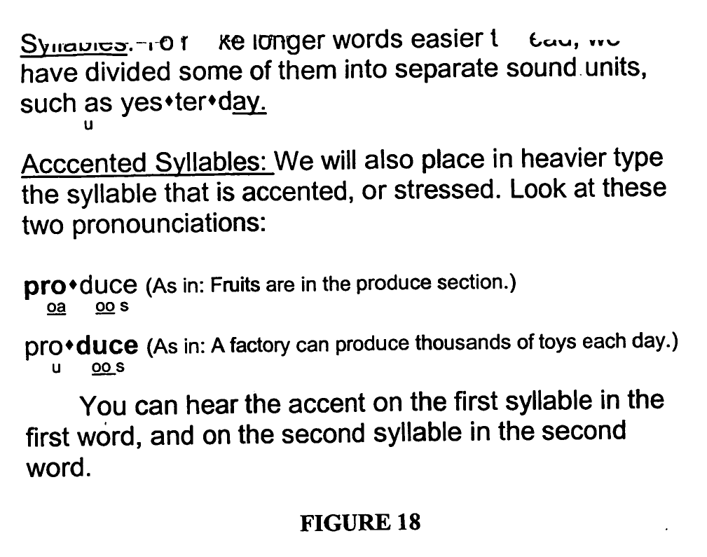

FIGS. 17 and 18 provide yet additional prompting instructions, as well as some practice words. FIG. 17 describes the use of faded out letters to designate which letters are silent versus which letters are pronounced. FIG. 18 focuses on separating and accenting syllables. Here, a diamond is used to separate the syllables, and heavier type is used to identify which syllables are accented.

It should be appreciated that alternative contemplated systems could be completely devoid of prompts, or could use different or additional prompts. Some children, for example, may well find prompts entirely distracting and annoying, and their parent may prefer to use systems that omit prompts altogether. For those children it would be useful to provide materials that omit the prompts altogether. On the other hand, selection of the preferred prompts was undertaken with considerable effort, and is not a mere design choice. Experimentation has established that underlining, for example, is much better tolerated than overlining. Experimentation has also established that the use of colored and faded letters provides increased retention by 57%.

The practice words of FIGS. 17 and 18 exemplify the currently most preferred presentation of the words and corresponding ITA. Those skilled in the art will appreciate that not all of the letters of a word are accompanied by adjacent ITA designations, but that many or even all of the words include some prompts.

Those skilled in the art will also appreciate that the ITA designations are positioned adjacent to the letters that they clarify. As used herein adjacent positioning means that the clarifying symbols are at least as close, and preferably closer, to the corresponding letters in the written word than to other letters of the word. This excludes phonetic spelling aids found in dictionaries, in which an entire word is followed by an entire phonetic spelling of the word. In especially preferred embodiments the clarifying symbols are written directly below the corresponding letters of the word.

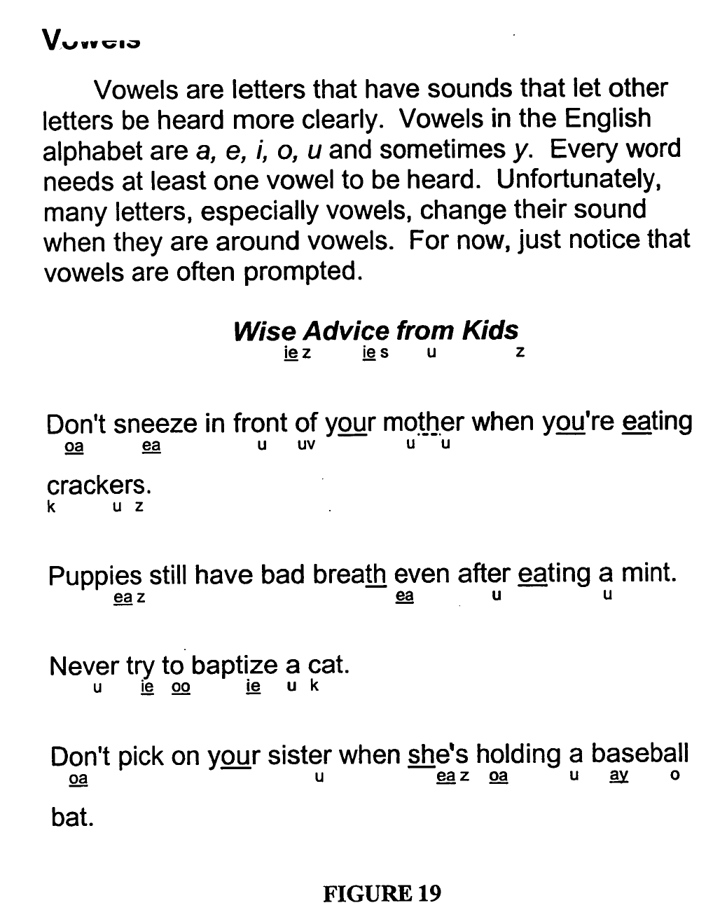

FIG. 19 is once again a page from a training book. Here the page provides additional instruction and practice in pronouncing vowels.

Systems and Methods

The Rocket Phonics™ concepts can be embodied in any number of ways; in training books, in teacher/parent guides, in videos, in computer programs and so forth. It is certainly preferred that the concepts be presented in a series of games and suggested variations, because children tend to spend more “time on task” if they are having fun.

A preferred method involves teaching phonetic reading using an initial teaching alphabet mostly or entirely consisting of the letters of the English alphabet, in which single ones of the letters represent corresponding short vowel sounds, and even more preferably in which combinations of the letters represent long vowel sounds display a line of words with ordinary spelling, in which some of letters in the words are accompanied by adjacent clarifying ones of the letters. In another aspect, preferred methods include displaying a line of words with ordinary spelling, and using symbols of the initial teaching alphabet to accompany some of the letters of the words. The words can be advantageously arranged in sentences of at least five words, and the symbols of the ITA can advantageously be placed below selected letters of at least some of the words as aids in pronunciation of the selected words.

Thus, specific embodiments and applications of phonics teaching methods and apparatus have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for teaching phonics, comprising a visual representation of a plurality of words using ordinary spelling, and adjacently positioned symbols that consist primarily or entirely of the letters of a standard alphabet are used assist in sounding out the words.

2. The system of claim 1 wherein the clarifying symbols are omitted for at least some of the letters.

3. The system of claim 1 wherein at least 90% of the clarifying symbols consists of standard letters.

4. The system of claim 1 wherein all of the clarifying symbols consist of standard letters.

5. The system of claim 1 wherein the standard letters and the clarifying symbols together comprise an initial teaching alphabet consisting of less than 44 phonograms.

6. The system of claim 1 wherein the standard letters and the clarifying symbols together comprise an initial teaching alphabet consisting of 36 phonograms.

7. The system of claim 1 further comprising a prompt to show when a plurality of the letters form a blended sound.

8. The system of claim 7 wherein the prompt comprises underlining of the plurality of the letters.

9. The system of claim 1 further comprising a coloration of a selected one of the standard letters to show that such letter is silent in the word.

10. The system of claim 1 further comprising a modification of a selected one of the standard letters to show that such letter is either silent or sounds according to the adjacent phonetic symbol.

11. The system of claim 10 wherein the modification comprises representing the selected letter using a particular coloration.

12. The system of claim 1 wherein differences in case of the letters are not used to represent differences in sound.

13. The system of claim 1 wherein the adjacently positioned clarifying symbols are placed below corresponding ones of the standard letters of at least some of the words.

14. The system of claim 1 further comprising a reading assist card having a window sized and dimensioned to focus attention on a subset of the words and corresponding ones of the adjacently positioned clarifying symbols.

15. An initial teaching alphabet consisting substantially of the letters a, b, c, d, e, f g, h, i, j, k, l, m, n, o, p, q, r, s, t, u, v, w, x, y, z, and combinations of the letters, in which words are regularly written using their ordinary spellings.

16. A method of teaching phonetic reading comprising using the initial teaching alphabet of claim 15 in which single ones of the letters represent corresponding short vowel sounds.

17. A method of teaching phonetic reading comprising using the initial teaching alphabet of claim 15 in which combinations of the letters represent long vowel sounds.

18. A method of teaching phonetic reading comprising displaying a line of words with ordinary spelling, and using symbols of the initial teaching alphabet of claim 15 to accompany some of the letters of the words.

19. A method of teaching phonetic reading comprising displaying display a sentence of at least five words with ordinary spelling, and placing symbols of initial teaching alphabet below selected ones of the words as aids in pronunciation of the selected words.

20. The method of claim 19 further comprising displaying at least one of the words without a corresponding one of the pronunciation aids.
